(19) United States
(12) Patent Application Publication
(10) Pub. No.: US 2023/0281781 A1
(43) Pub. Date: Sep. 7, 2023

(54) SYSTEM AND METHOD FOR DETECTING DEFECTS USING IR WAVELENGTH FOR DRY OPHTHALMIC LENSES

(71) Applicant: Emage Al Pte. Ltd., Singapore (SG)

(72) Inventors: Sy Hieu Dau, Bien Hoa City (VN); Hoang Bao Nguyen, Ho Chi Minh City (VN); Jia Yaw Tan, Gelang Patah (MY)

(73) Assignee: Emage Al Pte. Ltd., Singapore (SG)

(21) Appl. No.: 18/118,676

(22) Filed: Mar. 7, 2023

(30) Foreign Application Priority Data
Mar. 7, 2022 (SG) 10202202261T

(51) Int. Cl. G06T 7/00; G02C 7/04; H04N 23/74; G01M 11/02

(52) U.S. Cl. CPC G06T 7/0004; G02C 7/046; H04N 23/74; G01M 11/0228; G06T 2207/10048

(57) ABSTRACT

A system to inspect Dry Cosmetic contact lenses for defects such as imperfect structures, improper pattern prints, print smears, wrong colour, embedded foreign material or contaminants, wherein the said lens is printed with multilayers of ink on the anterior surface using at least one colourant and a binding polymer comprising: a) a Top camera to capture an image of the cosmetic lens; b) a Top illumination designed using IR wavelength LEDs positioned at an acute angle to the vertical axis and integrated with a lens system to produce a parallel and collimated illumination field; c) a bottom illumination designed using IR wavelength LEDs to illuminate the lens posterior; d) an optically transparent glass plate to accurately locate the lens at a predetermined position and also to diffuse the illumination; e) a contact lens under inspection placed on the transparent glass plate with its anterior surface facing the Camera and Top illumination; f) the Top and Bottom illumination designed using segmented LEDs arrangement, to provide programmable triggering of LED segments for intensity and trigger duration, dynamically.

### FIELD OF THE INVENTION

The present invention relates to an apparatus and method for detecting defects on cosmetic ophthalmic lenses. More specifically, the present invention relates to a method to detect defects and foreign material contaminants on dry cosmetic lenses using IR wavelength illumination contact lenses, suitable for integration as an inline inspection system on automatic ophthalmic lenses production machines.

### BACKGROUND OF THE INVENTION

The manufacturing of ophthalmic lenses, in particular single wear soft contact lenses, may be manufactured in a fully automated manufacturing line with the aid of reusable molds. The manufacturing process has moved ahead to offer end users an option to wear cosmetic lenses that have attractive patterns printed on them. The pattern is typically printed on the anterior surface of the ophthalmic lens using ink that contains at least one colorant and at least one binding polymer amongst other solvents, to form a thin film on the lens surface. The ink pattern may also comprise several layers of multi-colored inks to achieve a required pattern to cater for different user preferences. During the process of ink transfer from the lens mold to the anterior surface of the contact lens, there are instances where foreign material or contaminants can get embedded within the layers of the ink patterns. Ophthalmic lenses with defects such as imperfect structures or foreign material such as fibers or small pieces of uncertain material embedded between layers of ink or on the lens surface have to be detected and eliminated.

During inspection of such defects, the inspection system needs to extract the defects, identify, classify and sort them according to the manufacturing requirements, to enable high quality products to be shipped to the customers. Manual methods are slow and selective sample inspection of lenses pose an issue of inadequate quality checks, commonly associated with such methods. It is therefore essential and an important requirement for contact lens manufacturers to ensure 100% of the products produced are inspected and segregated according to their characteristics. Fast, accurate, reliable and consistent methods of inspection are necessary to be deployed to guarantee reliable product quality.

Several types of manual inspection systems for contact lenses exist, but one of the most popular systems involves the operators who can observe a magnified image of the ophthalmic lens through an optical system and manually extract the defective lens. Such systems are suitable for sample inspection and cannot be integrated into high speed automated manufacturing systems because of the time required to inspect each lens, making them unsuitable for such a purpose.

Some prior art automated inspection systems for ophthalmic lenses utilise visible range wavelength illumination lighting modules which are able to detect defects such as cuts, tears, bubbles and foreign material on clear lenses without any prints or patterns overlaid on them. However, when fibers and foreign materials get embedded between layers of prints on cosmetic ophthalmic lenses, conventional inspection systems fail to identify them as such defects are not enhanced or highlighted under illumination lighting modules designed using visible range wavelength LEDs.

### SUMMARY OF THE INVENTION

The invention provides a solution in the form of IR (IR) wavelength based illumination modules, a primary illumination means positioned on top of the lens and a secondary illumination means to illuminate the bottom of the lens. They are capable of highlighting the defects even if they exist between cosmetic ink layers, which visible wavelength illumination modules cannot achieve. The IR based illumination modules are capable of highlighting the outer shape of defects, while aiding identification of defects using software algorithms.

Therefore, it is an object of the invention to overcome the afore-mentioned disadvantages of the prior art and to suggest a method that greatly increases the efficiency of using IR LED based Illumination modules that are suitable for inspection of defects present between layers of ink a process that is typically used to produce cosmetic ophthalmic lens.

The present invention addresses at least one or more deficiencies of the conventional inspection systems.

In one aspect, the present invention provides an inspection system comprising an optically transparent plate having a recess preferably in the center, to locate the ophthalmic lens in a predetermined position with its convex side facing up towards the camera. The cosmetic lenses are manufactured using multiple layers of Silicone based ink printed in layers on the convex surface of the lens. During the printing of each layer, there is a possibility of ink smear, dust or other foreign material getting embedded between two layers of the ink or on the top layer of the print pattern. Depending upon the size of the defect whether it was created by the ink or by foreign material, it becomes difficult to detect the defect under conventional lighting. Therefore, an IR LED based illumination light source designed to illuminate specific areas or the entire ophthalmic lens is positioned at the bottom of the optically transparent plate comprising the Ophthalmic lens to be inspected. If the ophthalmic lens is defect free and without any foreign material stuck within the lens, the IR illumination is transmitted through the lens without any deviation or scattering, enabling an image to be captured, which is clear and transparent. However in the event of any defects or Foreign material occurring in the Ophthalmic lens, the IR rays of illumination is scattered and deviates from its normal path, enabling capturing an image that highlights the defects in the lens being inspected making them suitable for defect classification and subsequent sorting into their respective categories.

According to one aspect of the present invention, there is a method provided by combining the Schlieren method and the captured images of the cosmetic Ophthalmic lens and applying complex image processing algorithms that can effectively extract very minute defects. The Schlieren system is particularly useful for inspection where small changes in refractive index are visible. The direction of the light beam can be easily changed with small changes to the refractive index. This deviation in the rays of light at IR wavelength is pronounced which enables highlighting small defects with high degree of clarity and consistency in captured images.

According to another aspect of the present invention, there is a method provided for designing an illumination system using IR LEDs positioned at an acute angle to the vertical axis integrated with a lens system to produce a parallel and collimated illumination field. Combined with the penetration ability of IR LEDs wavelength and their characteristics to deviate from their normal path when passing through material of different refractive indexes, defects are easily highlighted through light scattering in and around defects in the lenses, including defects that are present in between layers of ink, in cosmetic Ophthalmic lenses.

In another aspect, the invention provides a method that preferably enables selective employment of certain segments of the illumination to be controlled for intensity and timing of the trigger pulses to highlight defects on the cosmetic and/or clear ophthalmic lens.

Further details and advantages of the invention may be seen from the description and the drawings that follow.

### BRIEF DESCRIPTION OF THE DRAWINGS

A complete understanding of the present invention may be gained by considering the following detailed description together with the accompanying drawings, in which:

FIG. 1 shows a preferred embodiment of the invention. The apparatus 100 comprises a High resolution Camera 10, an optical lens 20, to view the lens 40 positioned on glass platform 30, and an LED based illumination module 50 to direct the illumination 50 towards the contact lens 40, all of the above suitably aligned to the optical axis 25 of the apparatus. The illumination module 50 is controlled by a programmable strobing controller (not shown) to control the Camera and/or illumination trigger pulse width and the intensity of the LED segments.

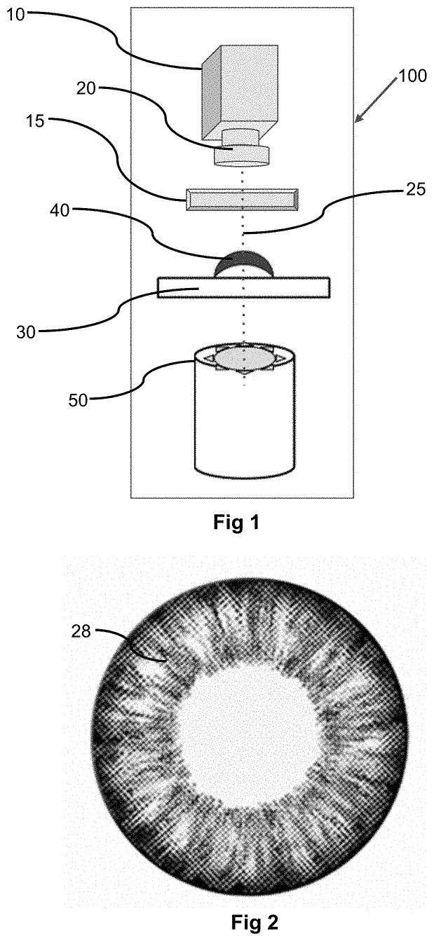

FIG. 2 shows an image of an Ophthalmic Cosmetic lens illuminated by a Top LED lighting module (15 in FIG. 1).

FIG. 3-6 shows an image of an Ophthalmic Cosmetic lens illuminated using the Backlit IR LED illumination module (50 in FIG. 1) and the various types of foreign material contaminants on the surface of the lens.

### DETAILED DESCRIPTION OF THE INVENTION

“Contact Lens or Ophthalmic Lens” refers to a flexible lens that can be placed on or within a wearer's eye. A contact lens can correct, improve, or altera user's eyesight, but that need not be the case. A contact lens can also add a cosmetic feature based on the type of colour and design that is printed on the anterior or otherwise referred to as the convex side of the lens. Cosmetic features may be applied in many forms. One commonly used method is the printing of such designs using an approved and appropriate material on soft lens, hard lens, or a hybrid lens. A contact lens can be in a dry state or a wet state. ‘Dry State’ refers to a soft lens in a state prior to hydration or the state of a hard lens under storage or use conditions. “Wet State” refers to a soft lens in a hydrated state. The “front or anterior surface” of a contact lens, as used herein, refers to the surface of the lens that faces away from the eye when applied and the anterior Surface, which is typically substantially convex, may also be referred to as the front curve of the lens. The “rear or posterior surface” of a contact lens, as used herein, refers to the surface of the lens that makes contact with the eye surface. The rear Surface, which is typically Substantially concave, may also be referred to as the base curve of the lens. A “colored contact lens” refers to a contact lens (hard or Soft) having a color image printed on the anterior surface. A color image can be a cosmetic pattern, for example, iris-like patterns, made-to-order (MTO) patterns, and the like. A color image can be a single color image or a multi-color image. A color image is preferably a digital image, but it can also be an analog image. A colored contact lens can be produced by printing a high quality color image directly on a contact lens layer by layer or in one go. To begin with a contact lens can be clear before it is printed upon or alternatively, a contact lens can be tinted prior to being printed upon. It is important to note that any cosmetic feature in a contact lens applied around the IRIS. The center area which is referred to as IRIS is usually clear. The methodology of printing will not be discussed as it is beyond the scope of this invention.

During the printing process it is possible that contaminants such as dust particles in various forms, smear of the printing material etc. can occur on the contact lens. Such products result in medically unfit lenses for use on the eyes due to the possibility of infection and other related problems.

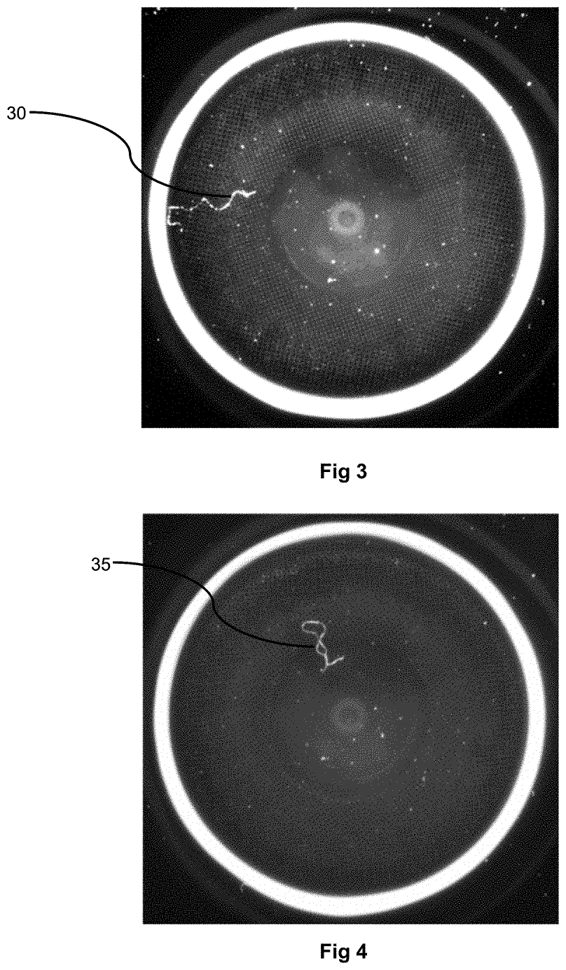

During the process of printing a pattern on the anterior surface of the contact lens, the formulation can also comprise other necessary components known to a person skilled in the art, such as, for example, a UV-absorbing agent, a visibility tinting agent (e.g., dyes, pigments, or mixtures thereof), antimicrobial agents (e.g., preferably silver nanoparticles), a bioactive agent, leachable lubricants, leachable tear-stabilizing agents, and mixtures thereof to achieve various patterns, during the process of which multiple types of contaminants are possible introduced between the layers of dyes and other layer. Defects embedded within such layers during the process of manufacture can get completely camouflaged, preventing conventional inspection systems to detect and reject them. In FIG. 2 image, the printed lens pattern is shown in bright field illuminated configuration. The illumination module 15 is triggered or energised to enhance the convex or anterior surface of the contact lens 40 located on the glass plate 30. Image in FIG. 2 can be analysed to extract defects in pattern, contrast, colour, smear and any other dimensional related issues. However if foreign material contamination is embedded within the cosmetic pattern on the lens surface, it is very difficult or impossible in most cases.

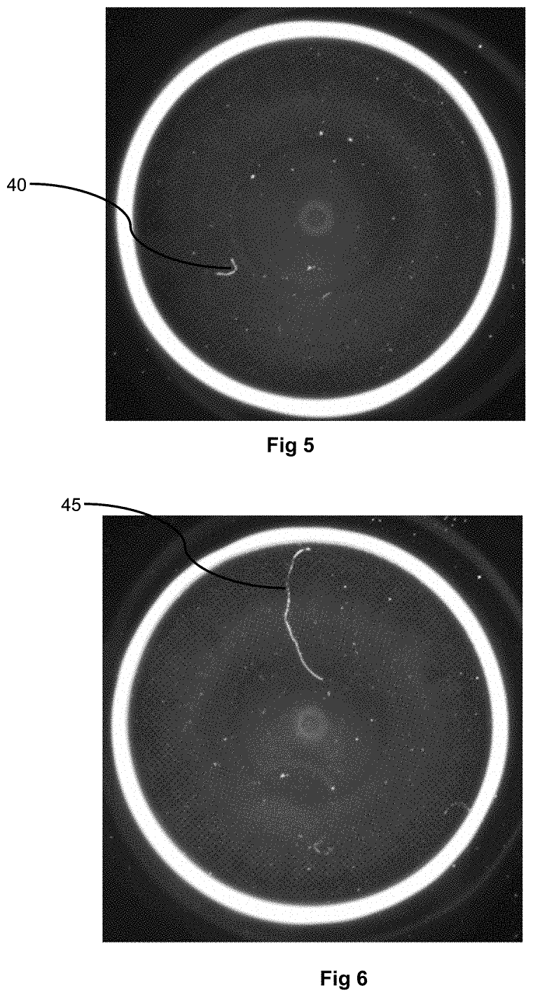

FIG. 3 shows an image of the contact lens illuminated with an IR LED based module, wherein the Cosmetic pattern printed on the anterior surface is not visible and the opaque area 30 indicates a contaminant or foreign material identified on the lens. The contrast of the contaminant is enhanced in the backlit illumination and more so when using an IR LED based illumination due to its wavelength.

Another example is in FIG. 4 wherein another foreign material 35. that highlighted and in yet another example foreign material 40 and 45 are indicated in FIGS. 5 and 6 respectively.

As evident from the images shown in FIGS. 4 to 6, when an opaque foreign substance is encountered by the IR rays of light, they cannot pass through and hence deviate from their normal path, a part of this light ray scattering will go into the optical lens and generate an image of the defect. This phenomenon is especially prominent when using IR LED based illumination which helps in detecting very fine particles that can affect the quality of the contact lens. Foreign material or contaminants can be easily detected by image processing, and the inspection accuracy can be improved as compared with the prior art. Subsequently, sorting the defective lenses and removing them increases productivity and efficiency of the manufacturing process resulting in good quality product delivered to the customer.

1. A system to inspect Dry Cosmetic contact lenses for defects such as imperfect structures, improper pattern prints, print smears, wrong colour, embedded foreign material or contaminants, wherein the said lens is printed with multilayers of ink on the anterior surface using at least one colourant and a binding polymer comprising:
a) a Top camera to capture an image of the cosmetic lens;
b) a Top illumination designed using IR wavelength LEDs positioned at an acute angle to the vertical axis and integrated with a lens system to produce a parallel and collimated illumination field;
c) a bottom illumination designed using IR wavelength LEDs to illuminate the lens posterior;
d) an optically transparent glass plate to accurately locate the lens at a predetermined position and also to diffuse the illumination;
e) a contact lens under inspection placed on the transparent glass plate with its anterior surface facing the Camera and Top illumination;
f) the Top and Bottom illumination designed using segmented LEDs arrangement, to provide programmable triggering of LED segments for intensity and trigger duration, dynamically.

2. A method to inspect Dry Cosmetic contact lenses for defects such as imperfect structures, improper pattern prints, print smears, wrong colour, embedded foreign material or contaminants, wherein the said lens is printed with multilayers of ink on the anterior surface using at least one colourant and a binding polymer the method comprising the steps of:
a) placing a Dry Cosmetic lens on a transparent glass surface with its anterior surface facing the Top Camera and Top illumination;
b) analysing the Bright field image of the Dry Cosmetic lens image captured using the Camera with the IR LEDs based Top illumination triggered ON and the Bottom illumination turned OFF;
c) Identifying if an enhancement of the image is required and appropriately selecting multiple segments of the Top Illumination module to highlight a specific area of the lens;
d) recapturing a Bright field image with a new Top illumination configuration and identifying the defect by detecting small changes illumination deviation due to scattering produced by materials of different refractive indexes, even if they are present in between layers of ink.

3. A method according to claim 2 wherein the images are analysed using the Schlieren system for inspection of small deviations in illumination deflection due to changes in refractive index, to identify embedded defects and contaminants in the lens.

4. A method to inspect dry cosmetic contact lenses for defects such as imperfect structures, improper pattern prints, print smears, wrong colour, embedded foreign material or contaminants, wherein the said lens is printed with multilayers of ink on the anterior surface using at least one colourant and a binding polymer the method comprising the steps of:
a) placing a Dry Cosmetic lens on a transparent glass surface with its anterior surface facing the Top Camera and Top illumination;
b) analysing the Dark field image of the Dry Cosmetic lens image captured using the Camera with the IR LEDs based Bottom illumination triggered ON and Top illumination turned OFF;
c) identifying if an enhancement of the image is required and appropriately selecting multiple segments of the Bottom Illumination module to highlight a specific area of the lens;
d) recapturing a Bright field image with a new Bottom illumination configuration and identifying the defect by detecting small changes in illumination deviation due to scattering produced by materials of different refractive indexes, even if they are present in between layers of ink.

5. A method according to claim 4 wherein the images are analysed using the Schlieren system for inspection of small deviations in illumination deflection due to changes in refractive index, to identify embedded defects and contaminants in the lens.

6. A method to inspect Dry Cosmetic contact lenses for defects such as imperfect structures, improper pattern prints, print smears, wrong colour, embedded foreign material or contaminants, wherein the said lens is printed with multilayers of ink on the anterior surface using at least one colourant and a binding polymer the method comprising the steps of:
e) placing a Dry Cosmetic lens on a transparent glass surface with its anterior surface facing the Top Camera and Top illumination;
f) analysing the image of the Dry Cosmetic lens image captured using the Camera with both the IR LEDs based illumination modules triggered ON;
g) Identifying if an enhancement of the image is required and appropriately selecting multiple segments of the both Illumination modules to highlight a specific area of the lens;
h) recapturing an image with new illumination configurations and identifying the defect by detecting small changes in illumination deviation due to scattering produced by materials of different refractive indexes, even if they are present in between layers of ink.

7. A method according to claim 4 wherein the images are analysed using the Schlieren system for inspection of small deviations in illumination deflection due to changes in refractive index, to identify embedded defects and contaminants in the lens.
